(19) United States
(12) Patent Application Publication
(10) Pub. No.: US 2016/0125758 A1
(43) Pub. Date: May 5, 2016

(54) ASSESSING COGNITIVE FUNCTION USING A MULTI-TOUCH DEVICE

(71) Applicant: Ohio University, Athens, OH (US)

(72) Inventors: Siang Lee Hong, Canal Winchester, OH (US); Chang Liu, Athens, OH (US)

(21) Appl. No.: 14/926,792

(22) Filed: Oct. 29, 2015

Related U.S. Application Data
(60) Provisional application No. 62/072,079, filed on Oct. 29, 2014.

(51) Int. Cl. G09B 19/00; G09B 5/00

(52) U.S. Cl. CPC G09B 19/00; G09B 5/00

(57) ABSTRACT

Systems and methods include assessing cognitive function of the individual as the individual engages cognitive exercises using a multi-touch device. Embodiments of the present disclosure relate to engaging the individual with the cognitive exercise via a user interface of the multi-touch device so that the individual implements a plurality of cognitive skills when engaging the cognitive exercise. Cognitive responses generated by the individual when engaging the cognitive exercise are received via the user interface of the multi-touch device. The cognitive data generated from the cognitive responses are analyzed to determine an assessment of the cognitive function associated with the individual. A cognitive function score is then determined from the assessment of the cognitive function associated with the individual in which the cognitive function score is representative of the cognitive function of the individual.

### CROSS-REFERENCE TO RELATED APPLICATIONS

This application is a U.S. Nonprovisional application which claims the benefit of U.S. Provisional Application No. 62/072,079 filed on Oct. 29, 2014, which is incorporated herein by reference in its entirety.

### BACKGROUND

As individuals age and/or are debilitated by degenerative disorders such as Parkinson's disease, the individuals may experience a decrease in their cognitive abilities to maintain velocity and/or precision in their movements. Such a decline in movement control may have a significant impact on the individuals' fine movements which may hinder impacted individuals to execute everyday tasks that require fine movements such as buttoning a shirt and/or operating a vehicle. As the difficulty in executing everyday tasks increases for impacted individuals, the independence and self-sufficiency of the impacted individuals decrease.

Early detection of a decline in an individual's cognitive abilities is crucial to addressing the decline in a sufficient manner to slow the decline. Typically, such early detection occurs when an individual routinely visits a physician for routine testing of the individual's cognitive abilities. However, such routine testing is often times inconvenient and/or unrealistic. In order for an individual to attain sufficient routine testing to adequately monitor the individual's cognitive abilities for any decline, requires that the individual schedule regular appointments with their physician several times a year which could be quite costly. Thus, the individual typically has their cognitive abilities tested at annual and/or semi-annual physician appointments. However, such sparse assessments are not sufficient to detect subtle declines in cognitive abilities so that when a substantial decline is identified, the decline may not be able to be slowed and/or reversed.

Conventionally, the cognitive abilities of the individual are evaluated by a physician that observes how the individual performs certain tasks. However, the assessment of the individual's cognitive abilities based on the performance of the individual in performing the tasks is subjective to the physician and can vary based on the physician's experience level with cognitive testing and expertise. This type of conventional approach not only requires that the individual visit the physician as discussed above but also relies on subjective data which can skew the assessment of the individual's cognitive abilities.

### BRIEF SUMMARY

Embodiments of the present invention relate to detecting a deficit in an individual's cognitive function while engaging in a cognitive exercise via a multi-touch device. Cognitive data captured by the multi-touch device as the individual engages the cognitive exercise is analyzed by the multi-touch device to provide an assessment to the individual. In an embodiment, a method detects a deficit in cognitive function associated with an individual based on cognitive data generated from the individual engaging in a cognitive exercise using a multi-touch device. The multi-touch device may engage the individual with the cognitive exercise via a user interface. The individual may implement a plurality of cognitive skills when engaging the cognitive exercise. A plurality of cognitive responses may be received via the user interface from the individual as the individual engages the cognitive exercise. The cognitive data generated from the plurality of cognitive responses may be analyzed to determine an assessment of the cognitive function associated with the individual. A cognitive function score may be determined from the assessment of the cognitive function associated with the individual. The cognitive function score is representative of the cognitive function of the individual.

In an embodiment, a multi-touch device detects a deficit in cognitive function associated with an individual based on cognitive data generated from the individual engaging in a cognitive exercise using a multi-touch device. A user interface is configured to engage the individual with the cognitive exercise. The individual may implement a plurality of cognitive skills when engaging the cognitive exercise. The user interface is also configured to receive a plurality of cognitive responses from the individual as the individual engages the cognitive exercise. An analysis module is configured to analyze the cognitive data generated from the plurality of cognitive responses to determine an assessment of the cognitive function associated with the individual. A determination module is configured to determine the cognitive function score from the assessment of the cognitive function associated with the individual. The cognitive function score may be representative of the cognitive function of the individual.

Further embodiments, features, and advantages, as well as the structure and operation of the various embodiments, are described in detail below with reference to the accompanying drawings.

### BRIEF DESCRIPTION OF THE DRAWINGS/FIGURES

Embodiments are described with reference to the accompanying drawings. In the drawings, like reference numbers may indicate identical or functionally similar elements.

FIG. 1 shows an illustration of a cognitive function system;

FIG. 2 is a flowchart showing an example method of assessing the cognitive function of the individual from cognitive data generated during engagement with a cognitive exercise;

FIG. 3 depicts an example matching game cognitive exercise configuration;

FIG. 4 depicts an example sequence tracing game configuration; and

FIG. 5 depicts a detailed view of an exemplary cognitive function system for assessing the cognitive function of the individual from cognitive data generated during engagement with a cognitive exercise.

### DETAILED DESCRIPTION

In the Detailed Description herein, references to “one embodiment”, “an embodiment”, an “example embodiment”, etc., indicate that the embodiment described may include a particular feature, structure, or characteristic, by every embodiment may not necessarily include the particular feature, structure, or characteristic. Moreover, such phrases are not necessarily referring to the same embodiment. Further, when a particular feature, structure, or characteristic may be described in connection with an embodiment, it may be submitted that it may be within the knowledge of one skilled in the art to affect such feature, structure, or characteristic in connection with other embodiments whether or not explicitly described.

The following detailed description refers to the accompanying drawings that illustrate exemplary embodiments. Other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the detailed description is not meant to limit the embodiments described below.

In an embodiment, an individual may have a deficit in their cognitive function detected by routinely engaging in cognitive exercises via a multi-touch device. The cognitive exercises may trigger the individual to implement several cognitive skills when engaging the cognitive exercises. For example, the cognitive exercises may intertwine the cognitive skills of memory and motor control together so that the cognitive function may be adequately assessed. Simply requiring an individual to implement their memory skills when engaging in the cognitive exercises may not provide as adequate assessment as requiring an individual to simultaneously implement their memory skills as well as their motor control skills. For example, the individual's engagement with a cognitive exercise such as a matching game not only evaluates the individual's memory in the individual's attempt to select matches but also evaluates the individual's motor control as the individual executes each selection.

In implementing their cognitive skills, the individual may generate cognitive responses that are captured by the multi-touch device as the individual engages the cognitive exercise. For example, as the individual engages in the matching game, the multi-touch device may capture each selection that the individual makes during the matching game session. The cognitive responses then generate cognitive data that the multi-touch device may then analyze to assess the cognitive function of the individual. For example, the cognitive responses of the individual generates cognitive data such as accuracy in selecting each card in attempting to form a match, the amount of time taken between each selection, as well as the physical location on the card that the individual actually selected the card. Such cognitive data intertwines both memory skills in regards to the accuracy and the amount of time between selections as well as motor skills in regards to the physical location on the card that the individual touched.

The multi-touch device may then generate a cognitive score incorporating the cognitive data where the cognitive score is representative of the cognitive function of the individual. Due to the convenience of engaging in the cognitive exercises via a multi-touch device and receiving a cognitive score, the individual may much more routinely have their cognitive function evaluated as compared to having to have a physician do such an assessment on a significantly less frequent basis. Further, the cognitive data generated from the intertwining of cognitive skills coupled with the analysis of such data by the multi-touch device may minimize the subjectivity often times associated with the cognitive assessment executed by a physician and thus may provide a more consistent assessment to the individual on a much more frequent basis. An increased frequency in assessment as well as an increase in consistency in the assessment may enable the individual to recognize a subtle decline in their cognitive function and have such a decline addressed by a physician so that the decline may be slowed and/or reversed.

### System Overview

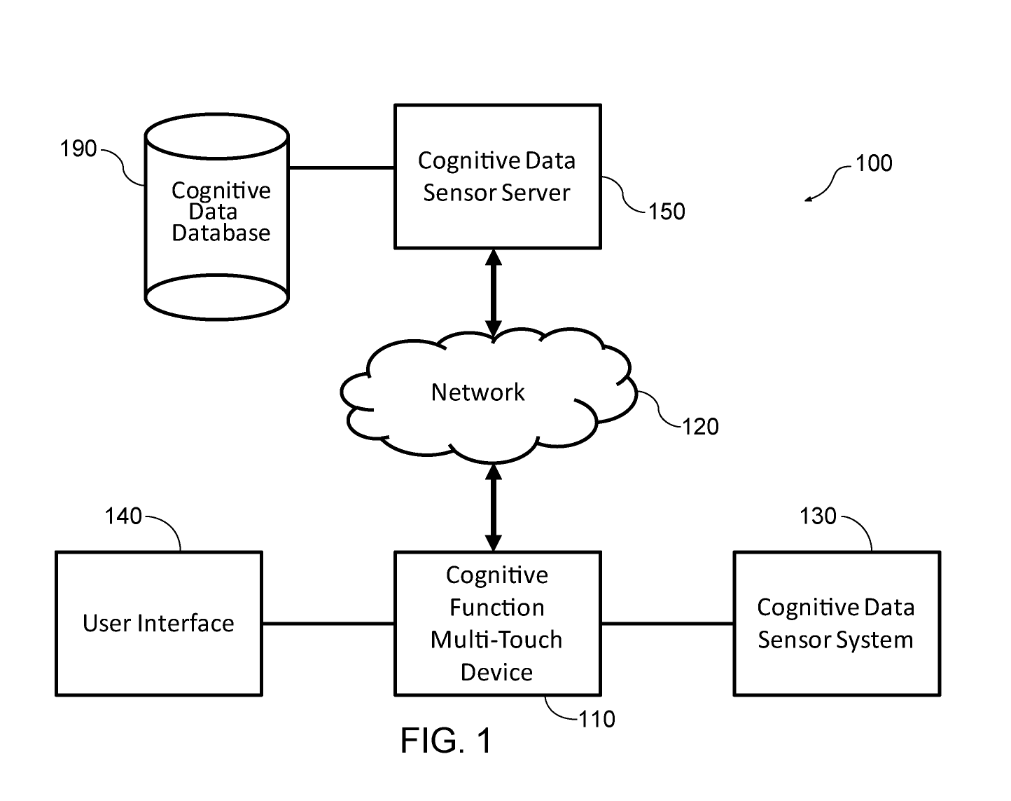

As shown in FIG. 1, cognitive function system 100 includes a cognitive function multi-touch device 110, a network 120, a cognitive data sensor system 130, a user interface 140, a cognitive data sensor server 150, and a cognitive data database 190.

Cognitive function multi-touch device 110 may be a device that is capable of electronically communicating with other devices while having a multi-touch display. The multi-touch display has the ability to recognize the presence of two or more points in contact with the surface of the multi-touch display. Examples of cognitive function multi-touch device 110 may include a mobile telephone, a smartphone, a workstation, a portable computing device, other computing devices such as a laptop, or a desktop computer, cluster of computers, set-top box, a computer peripheral such as a printer, a portable audio, and/or video player, a payment system, a ticketing writing system such as a parking ticketing system, a bus ticketing system, a train ticketing system or an entrance ticketing system to provide some examples, or in a ticket reading system, a toy, a game, a poster, packaging, an advertising material, a product inventory checking system and or any other suitable electronic device with a multi-touch display that will be apparent to those skilled in the relevant art(s) without departing from the spirit and scope of the invention.

In an embodiment, multiple modules may be implemented on the same multi-touch device. Such a multi-touch device may include software, firmware, hardware, or a combination thereof. Software may include one or more applications on an operating system. Hardware can include, but is not limited to, a processor, memory, and/or graphical user interface display. Cognitive function multi-touch device 110 may store the cognitive data captured by cognitive data sensor system 130.

An individual engaged in an identity authentication session may interact with cognitive function multi-touch device 110 via user interface 140. User interface 140 may include a multi-touch display that has the ability to recognize the presence of two or more points in contact with the surface of the multi-touch display. User interface 140 may include any type of display device including but not limited to a touch screen display, a cathode ray tube (CRT) monitor, a liquid crystal display (LCD) screen, and/or any other type of display device that includes a multi-touch display that will be apparent from those skilled in the relevant art(s) without departing from the spirit and scope of the present disclosure.

One or more cognitive data sensor systems 130 may connect to one or more cognitive function multi-touch devices 110. Cognitive data sensor system 130 may include one or more sensors that capture cognitive data that is the physical movement of an individual. Cognitive data sensor system 130 may include a video imaging system, an infrared imaging system, a photographic imaging system, an air sensing system, a thermal sensing system, a motion sensor that is capable of capturing two-dimensional data with a commercially available device such as a Kinect motion sensing input device by Microsoft, other motion sensing systems that include sensors that are associated with a multi-touch communications device that that can also be used without departing from the spirit and scope of the present disclosure. Cognitive data sensor system 130 detects cognitive data as the individual executes a series of motions when engaging in a cognitive exercise and in doing so touches the multi-touch display of user interface 140. For example, cognitive data sensor system 130 can detect a sequence of positions the individual follows on the multi-touch display of user interface 140 when tracing a sequence displayed by user interface 140. Cognitive data sensor system 130 tracks the path of the individual's movements over time as the individual traces the sequence as well as other variables, such as the amount of time taken to connect dots within the sequence, as is explained hereinafter.

As shown, cognitive function multi-touch device 110 streams the cognitive data to cognitive data sensor server 150 via network 120. Network 120 includes one or more networks, such as the Internet. In some embodiments of the present invention, network 120 may include one or more wide area networks (WAN) or local area networks (LAN). Network 120 may utilize one or more network technologies such as Ethernet, Fast Ethernet, Gigabit Ethernet, virtual private network (VPN), remote VPN access, a variant of IEEE 802.11 standard such as Wi-Fi, and the like. Communication over network 120 takes place using one or more network communication protocols including reliable streaming protocols such as transmission control protocol (TCP). These examples are illustrative and not intended to limit the present invention.

One or more cognitive data sensor servers 150 may connect to one or more cognitive function multi-touch devices 110 via network 120. Cognitive data sensor servers 150 may include a data acquisition system, a data management system, intranet, conventional web-server, e-mail server, or file transfer server modified according to one embodiment. Cognitive data sensor server 150 is typically a device that includes a processor, a memory, and a network interface, hereinafter referred to as a computing device or simply “computer.” Cognitive data sensor server 150 may store the cognitive data captured by cognitive data sensor system 130.

Cognitive function multi-touch device 110, cognitive data sensor server 150, and cognitive data database 190 may share resources via network 120. For example, cognitive data sensor server 150 may retrieve captured average cognitive data that is associated with an average individual with a substantially similar age as the individual from cognitive data database 190 and provide such average cognitive data to cognitive function multi-touch device 110. Cognitive function multi-touch device 110 may also provide cognitive data captured from the individual when tracing the sequence via network 120. Based on the cloud computing configuration, the interaction between cognitive function multi-touch device 110, cognitive data sensor server 150, and cognitive data database 190 may not be limited to a single computing device. For example, a plurality of computing devices may update cognitive data database 190 via network 120 with captured cognitive data.

### Cognitive Function Evaluation

Cognitive function multi-touch device 110 may assess the cognitive function of an individual based on cognitive data generated from cognitive responses that the individual implements when engaging a cognitive exercise provided by cognitive function multi-touch device 110. The cognitive exercise may require the individual to implement a plurality of cognitive skills simultaneously in order to engage the cognitive exercise. As a result, the cognitive responses generated by the individual as the individual engages the cognitive exercise may generate cognitive data that is representative of the cognitive skills being implemented simultaneously by the individual. An embodiment consistent with the invention captures the cognitive data and then analyzes the cognitive data to determine an assessment of the cognitive function associated with the individual. The cognitive data generated by the simultaneous implementation of the cognitive skills may provide an accurate assessment of the individual's cognitive function. A cognitive function score may then be determined from the assessment and provided to the individual so that the individual may easily comprehend their current state of cognitive function.

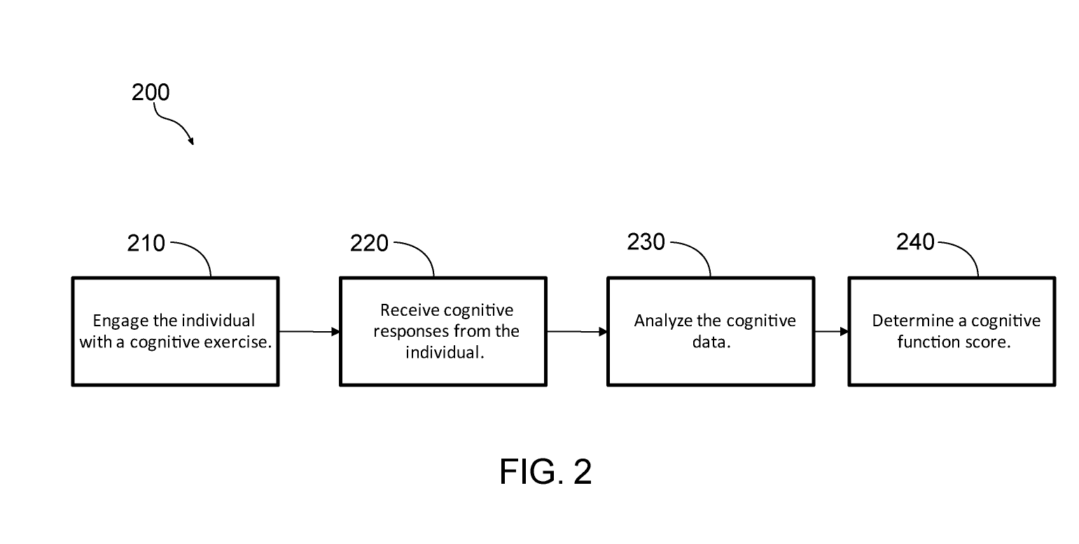

One such implementation of assessing the cognitive function of the individual from cognitive data generated during engagement with a cognitive exercise is illustrated by process 200 in FIG. 2. Process 200 includes four primary steps: engage the individual with a cognitive exercise 210, receive cognitive responses from the individual 220, analyze the cognitive data 230, and determine a cognitive function score 240. Steps 210-240 are typically implemented in a computer, e.g., via software and/or hardware, e.g., cognitive function multi-touch device 110 of FIG. 1.

In step 210, cognitive function multi-touch device 110 may engage the individual with a cognitive exercise. A cognitive exercise is an exercise that engages an individual's cognitive skills. Cognitive skills may be skills associated with an individual's mental abilities and/or movement control that an individual may implement when attempting to solve a problem such as a cognitive exercise. For example, cognitive skills may include processes related to knowledge, attention, memory, judgment, evaluation, reasoning, problem solving, decision making, comprehension and/or any other cognitive skill relative to mental abilities and processes that will be apparent to those skilled in the relevant art(s) without departing from the spirit and scope of the present disclosure. Cognitive skills may also include movement control which is the ability of a human to control voluntary movements. Particularly, movement control includes fine motor skills that provide a human the ability to coordinate small muscle movements which occur in body parts of the human in coordination with the eyes of the human.

In an embodiment, the cognitive exercise may require that the individual intertwine a plurality of cognitive skills when attempting to complete the cognitive exercise so that individual implements multiple cognitive skills simultaneously when engaging the cognitive exercise. The intertwining of cognitive skills may provide a more accurate assessment as to the individual's cognitive function as to assessing the individual based on a single cognitive skill. The individual may emphasize a single cognitive skill when the cognitive exercise requires that the individual only engage a single cognitive skill to complete the cognitive exercise. In such a case, the assessment of the cognitive function of the individual may be skewed because the individual was able to emphasize the single cognitive skill and mask any deficiencies that may be present. However, the individual may no longer be able put such an emphasis on a single cognitive skill when the individual is required to implement multiple cognitive skills simultaneously to engage the cognitive exercise. Thus, the individual may no longer be able to mask deficiencies in their cognitive function providing a more accurate assessment of cognitive function.

For example, a cognitive exercise may include a matching game where cards are displayed to the individual via user interface 140 of cognitive function multi-touch device 110. Each card includes a figure that is hidden from the individual. The goal of the matching game is for the individual to select a card via user interface 140 and when doing so the figure associated with the selected card is displayed to the individual. The individual then selects a second card in an attempt to match the figure associated with the first card. The cognitive skill of memory may be implemented by the individual in determining where each figure is located to obtain matches but also the cognitive skill of fine motor in determining a position on each selected card that the individual touches relative to the multi-touch display of user interface 140. The individual cannot simply emphasize on determining which card is a match but also has to emphasize the position on the card that the individual touches. As a result, both cognitive skills of memory and fine motor may be implemented in the assessment of the individual's cognitive function.

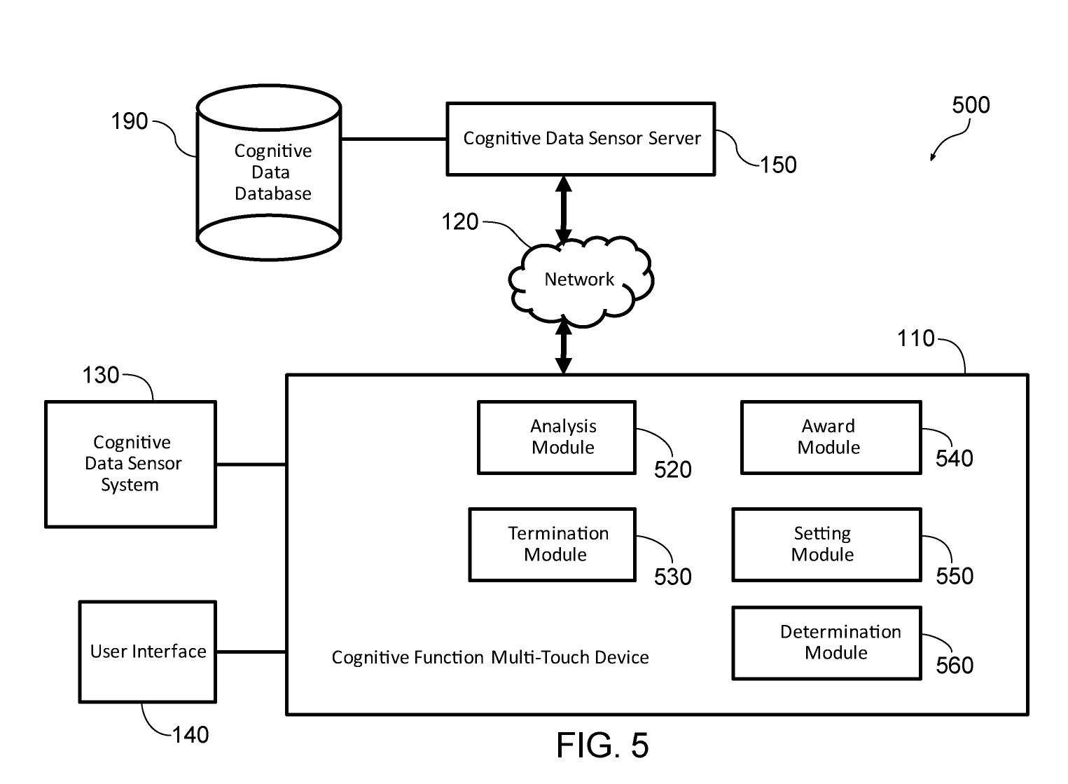

A cognitive exercise is an exercise that requires the individual to implement cognitive skills when completing the exercise. Cognitive exercises may include but are not limited to matching games, sequence games and/or any other cognitive exercise that requires the individual to implement cognitive skills when completing the exercise that will be apparent to those skilled in the relevant art(s) without departing from the spirit and scope of the present disclosure. The cognitive function of the individual represents the overall ability of the individual to successfully engage in tasks requiring cognitive skills. The individual may be any person that is engaging cognitive function multi-touch device 110 with the intent to have their cognitive function assessed. In an example embodiment, step 210 may be performed by user interface 140 as shown in FIG. 5 and discussed in more detail below.

As the individual engages the cognitive exercise via user interface 140, in step 220, the individual generates cognitive responses in engaging the cognitive exercise that may be received by user interface 140. Cognitive responses are responses generated by the individual involving cognitive skills which are triggered by the individual attempting to complete the cognitive exercise.

For example in the cognitive exercise of the matching game, cognitive responses generated by the individual include the selection of each card, the position on each card that the individual touches the card when selecting, and the amount time taken by the individual between selections. In the example in the cognitive exercise of tracing a sequence of dots, cognitive responses generated by the individual include the selection of each dot in the sequence, the amount of time taken by the individual between selections, and the path the individual took in connecting each dot in the sequence. Cognitive response may include any response implementing cognitive skills that is generated by the individual in response to engaging the cognitive exercise that will be apparent to those skilled in the relevant art(s) without departing from the spirit and scope of the present disclosure. In an example embodiment, step 220 may be performed by user interface 140 as shown in FIG. 5 and discussed in more detail below.

In step 230, cognitive data may be generated from the cognitive responses executed by the individual as the individual engages the cognitive exercise and then analyzed to determine an assessment of the cognitive function of the individual. Cognitive data capturing sensors included in cognitive data sensor system 130 may capture the cognitive data as the individual executes the cognitive responses when engaging the cognitive exercise. Cognitive data is the result of cognitive skills that the individual implements when engaging the cognitive exercise.

The cognitive data when analyzed relative to each other, which is to be discussed in greater detail below, may provide an accurate assessment of the overall cognitive function of the individual. Each cognitive data generated from each cognitive response may provide an indication as to the cognitive function of the individual. As noted above, the cognitive exercise may require the individual to generate cognitive responses that intertwine cognitive skills so that the individual may not emphasize a single cognitive skill more so than another cognitive skill. As a result, each cognitive data that is analyzed relative to each other cognitive data may provide an accurate assessment of the cognitive function of the individual so that any decline in the cognitive function may be identified in a timely manner.

For example in the cognitive exercise of the matching game, cognitive data extracted from the cognitive responses generated by the individual include the overall accuracy in the individual's selection of each card when attempting to find a match, the amount of time that the individual takes between selections, the amount of deviation from the center of each card when the individual touches each card, the amount of deviation from where the individual touches each card, and the amount of duplication in card selecting.

Each cognitive data may then be analyzed relative to each other cognitive data to determine an accurate assessment of the individual's cognitive function. For example, a greater weight may be applied each time the individual duplicates a selection of a card when attempting to find a match. After the individual initially selects a card, theoretically the individual should remember the figure associated with that particular card. Each time the individual incorrectly duplicates the selection of the card in that the individual selects the card incorrectly when attempting to find a match indicates that the individual's short term memory may be weak and receives a greater weight in the overall analysis of the cognitive data to determine the assessment of the individual's cognitive function.

In the example in the cognitive exercise of tracing the sequence of dots, cognitive data extracted from the cognitive responses generated by the individual include the overall accuracy in the individual's selection of each dot in the sequence, the amount of time taken between selections, whether the individual crosses other dots not included in the sequence of dots when completing the trace, and where in the sequence did the individual select the incorrect dot.

Each cognitive data may then be analyzed relative to each other cognitive data to determine an accurate assessment of the individual's cognitive function. For example, a greater weight may be applied each time the individual selects an incorrect dot early in the sequence of dots as compared to later in the sequence. Each time the individual correctly completes the trace of the sequence of dots, an additional dot is added to the previous sequence so that the subsequent sequence of dots is identical to the previous sequence with the addition of the additional dot. If the individual selects an incorrect dot early in the sequence as compared to later in the sequence, then that is an indication of weak short term memory for the individual. The individual had already successfully navigated the early sequence of dots but failed to remember the early sequence of dots when completing a subsequent sequence of dots that is longer than the previous sequences. Thus, a greater weight is associated to such cognitive data in the overall analysis of the cognitive data to determine the assessment of the individual's cognitive function. The cognitive skills may include any cognitive skill generated by the cognitive responses of the individual that will be apparent to those skilled in the relevant art(s) without departing from the spirit and scope of the present disclosure.

Cognitive data sensor system 130 may be coupled to the multi-touch display of user interface 140 so that cognitive data sensor system 130 may capture the motion-based behavior data generated as the individual engages the cognitive exercise with the multi-touch display. The individual may also be within proximity of the multi-touch display so that the cognitive data capturing sensors included in cognitive data sensor system 130 that are coupled to the multi-touch display can adequately capture the cognitive data generated from the cognitive responses executed by the individual when engaging the cognitive exercise via the multi-touch display. Cognitive data sensor system 130 may continuously capture the cognitive skill data as the individual engages the cognitive exercise. In an example embodiment, step 230 may be performed by analysis module 520 as shown in FIG. 5 and discussed in more detail below.

The captured cognitive data is stored in cognitive data database 190. The cognitive data is stored in cognitive data database 190 as associated with the individual that generated the cognitive data. Average cognitive data that is associated with an average individual of substantially similar age as the individual is also stored in cognitive data database 190. The cognitive data may be compared to the average cognitive data to determine a cognitive function score that is to be discussed in further detail below.

After the cognitive data has been analyzed so that an assessment of the cognitive function of the individual has been determined, in step 240, a cognitive function score may be determined. The cognitive function score may be representative of the cognitive function of the individual and may provide an easily understandable metric to the individual of the individual's cognitive function.

As noted above, each cognitive data may be analyzed in reference to each other cognitive data so that an accurate assessment of the individual's cognitive function may be determined. However, such an analysis of the cognitive data may not be easily deciphered by the individual so that the individual may easily understand the current state of their cognitive function. In order to provide an easily understood metric of the individual's cognitive function, the cognitive data obtained from the cognitive responses generated by the individual during the cognitive exercise may be compared to average cognitive data that is stored in cognitive data database 190.

Average cognitive data is the mean of cognitive data generated by other individuals with what is considered average cognitive function so that the average cognitive data is representative of what an average individual with average cognitive function would generate when engaging the cognitive exercise. For example, average cognitive data is the mean of cognitive data generated by other individuals that have not suffered a deficit in cognitive function but also do not have exceptional cognitive function. As a result, the cognitive data generated by the individual may be compared to the average cognitive data to determine how the individual's cognitive function compares to the cognitive function of the average individual.

The average cognitive data may be stored in cognitive data database 190 relative to age. The cognitive data of the individual may be compared to the average cognitive data of the average individual that has an age substantially similar to the individual. A slight deficit in cognitive function is expected for elderly individuals while any deficit in cognitive function is not likely for younger individuals. As a result, comparing the cognitive data of the individual to the average cognitive data of the average individual with a substantially similar age as the individual may provide a more accurate metric to the individual as to the state of the individual's cognitive function.

The analysis of each cognitive data relative to each other cognitive data as well as the comparison of the cognitive data to the average cognitive data for an average individual of a substantially similar age of the individual may then be incorporated into an overall cognitive function score for the individual. The cognitive function score for the individual may be an easily understood metric that is an accurate representation of the individual's cognitive function. For example, a cognitive function score that is typical for an average individual with a substantially similar age as the individual is indicative that the individual has not suffered a decline in cognitive function. However, a cognitive function score that is below what an average individual with a substantially similar age as the individual is indicative that the individual has suffered a decline in cognitive function so the individual may address the deficit in cognitive function with a physician in a timely manner so that the deficit may be slowed and/or reversed. In an example embodiment, step 240 may be performed by determination module 560 as shown in FIG. 5 and discussed in more detail below.

### Cognitive Exercise—Matching Game Example

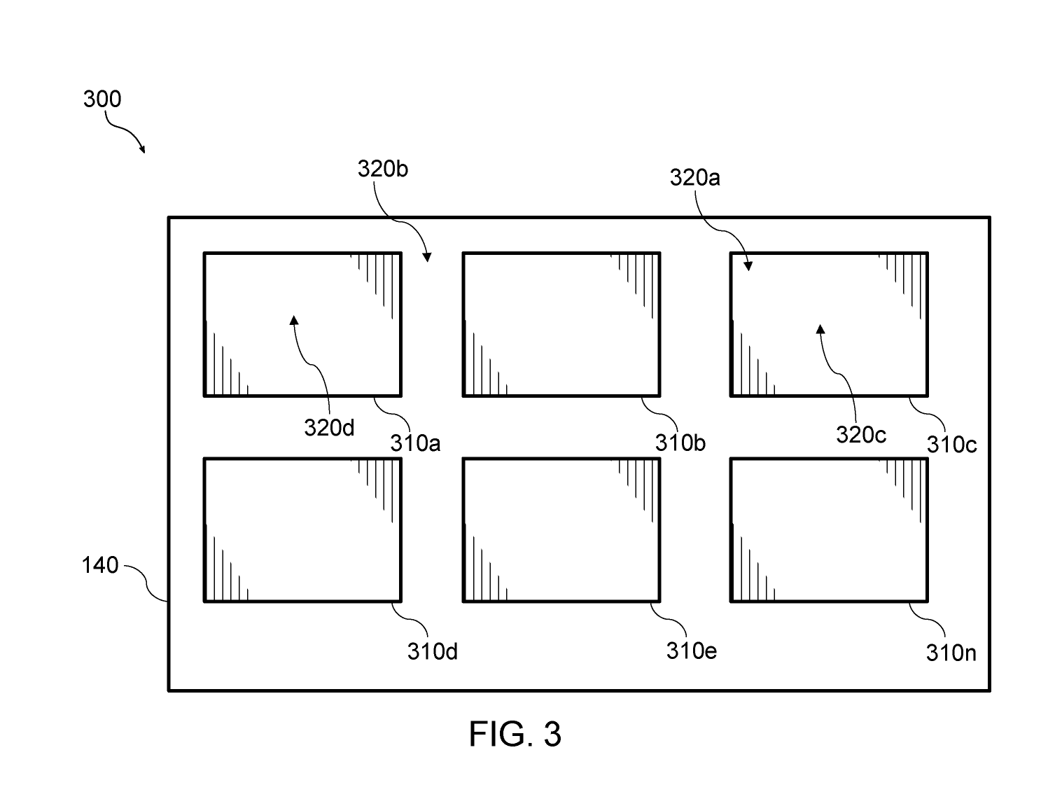

As noted above, cognitive function multi-touch device 110 may engage the individual with a cognitive exercise that includes a matching game in order to assess the cognitive function of the individual. As shown in FIG. 3, an example of a matching game displayed by user interface 140 to the individual can be seen with matching game cognitive exercise configuration 300 includes user interface 140 that displays a plurality of matching cards 310(a-n) to the individual where n is an even integer greater than or equal to four.

Each pair of matching cards included in matching card 310(a-n) include substantially similar figures with each pair of matching cards including different figures. For example, matching card 310(a) and 310(e) include a figure of an apple, matching card 310(b) and matching card 310(d) include a figure of an orange, and matching card 310(c) and matching card 310(n) include a figure of a banana. Although matching game cognitive exercise configuration 300 exhibits a total of six cards including three pairs of cards with each pair depicting substantially similar figures, any even number of total cards including any number of pairs of cards with each pair of cards depicting substantially similar figures may be used that will be apparent to those skilled in the relevant art(s) without departing from the spirit and scope of the invention.

As the individual initially engages the matching game cognitive exercise, each matching card 310(a-n) are displayed to the individual via user interface 140 with each of the figures associated with each matching card 310(a-n) hidden from the individual. The individual may then make an initial selection in selecting a first matching card 310(a-n) via user interface 140 where user interface 140 may then display the figure associated with the selected first matching card 310(a-n). User interface 140 may then display the figure associated with the selected first matching card 310(a-n) for a period of time. For example, the individual selects matching card 310a. User interface 140 then displays the figure of an apple associated with matching card 310a for a period of 1 second. The period of time that user interface 140 displays the figure associated with the selected first matching card 310(a-n) may be any period of time suitable to generate cognitive data that will be apparent to those skilled in the relevant art(s) without departing from the spirit and scope of the invention.

User interface 140 may then terminate the display of the figure associated with the selected first matching card 310(a-n) after the period of time has expired. In an embodiment, user interface 140 may also terminate the display of the figure associated with the selected first matching card 310(a-n) when the individual selects a second matching card 310(a-n) so that user interface 140 displays a single figure associated with a single matching card 310(a-n) at a time. The individual may then select a second matching card 310(a-n) with the goal of finding a match to the figure associated with the first matching card 310(a-n) selected by the individual. The termination of the display of the figure associated with each currently selected matching card 310(a-n) may be performed by termination module 530 of FIG. 5 as will be discussed in further detail below.

This process may continue as the individual continues to select matching cards 310(a-n) with the attempt of finding a match for each pair of matching cards 310(a-n) with substantially similar figures. The individual may be awarded a match when the individual selects two matching cards 310(a-n) in contiguous selections that have substantially similar figures. For example, the individual may be awarded a match when the individual selects matching card 310a that includes a figure of an apple with a first selection and then selects matching card 310e that also includes a figure of an apple in the immediate selection following the selection of matching card 310a. The awarding of a match may be performed by termination module 540 of FIG. 5 as will be discussed in further detail below.

As noted above, the cognitive responses generated by the individual as the individual engages in the matching game cognitive exercise may be received by user interface 140 and the cognitive data generated from the cognitive responses may be analyzed so that an assessment of the cognitive function of the individual may be determined along with a cognitive function score. For example, the matching game cognitive exercise may require that the individual implement cognitive skills such as but not limited to working memory in remembering each figure associated with each matching card 310(a-n) that the individual has selected, timing in having an understanding as to when the period of time each selected matching card 310(a-n) is to be displayed, attention in searching for each match, and impulsivity in attempting to select a subsequent matching card 310(a-n) before the period of time in which the currently selected matching card 310(a-n) is no longer displayed. Such an intertwining of cognitive skills may limit the emphasis that the individual can give to any single cognitive skill without having a detriment to the other cognitive skills so that an accurate assessment of the individual's cognitive function may be determined.

In regards to the cognitive skill of working memory, cognitive data relative to each matching card 310(a-n) that the individual selects may be obtained and analyzed by cognitive function multi-touch device 110. Each time the individual selects each matching card 310(a-n) multiple times may be an indicator that the individual's short term memory is not retaining the figure associated with each selected matching card 310(a-n) and may be weighted towards the individual having a decline in cognitive function.

For example, the individual initially selects matching card 310(a) that includes the figure of the apple. Then after making multiple selections, the individual selects matching card 310(n) that includes the figure of the banana. With the contiguous selection immediately following the selection of matching card 310(n) that includes the figure of the banana, the individual selects matching card 310(a) that includes the figure of the apple. The individual failed to recall when the individual previously selected matching card 310(a) that revealed to the individual the figure of the apple associated with matching card 310(a) that that the figure of the apple is indeed associated with the figure of the apple. Rather, the individual incorrectly presumed that matching card 310(a) included a figure of a banana. Such cognitive data may be weighted according by cognitive function multi-touch device 110 to assess a deficit in cognitive function.

In regards to the cognitive skill of timing in having an understanding as to when the period of time each selected matching card 310(a-n) is to be displayed, cognitive function multi-touch device 110 may analyze cognitive data associated with when the individual attempts a contiguous selection of matching card 310(a-n) after the period of time in which the current selection of matching card 310(a-n) is displayed to the individual via user interface 140 has expired. The longer the individual takes in selecting a contiguous selection of matching card 310(a-n) after the period of time in which the current selection of matching card 310(a-n) is displayed to the individual via user interface 140 has expired is indicative that the individual may not recall where a match to the current selection of matching card 310(a-n) may be located. Such cognitive data may be weighted accordingly by cognitive function multi-touch device 110 to assess a deficit in cognitive function.

In regards to the cognitive skill of attention in searching for each match, cognitive function multi-touch device 110 may analyze cognitive data associated with the methodology in which the individual selects each matching card 310(a-n). If the individual is randomly selecting each matching card 310(a-n) with complete disregard as to the figure associated with each matching card 310(a-n), then such cognitive data may be representative of the individual having a deficit in cognitive function and may be weighted accordingly by cognitive function multi-touch device 110.

In regards to the cognitive skill of impulsivity in attempting to select a subsequent matching card 310(a-n) before the period of time in which the currently selected matching card 310(a-n) is no longer displayed, cognitive function multi-touch device 110 may analyze cognitive data associated with selections of matching cards 310(a-n) made before the period of time in which the current selection of matching card 310(a-n) is displayed terminates. Each time that the individual selects a subsequent matching card 310(a-n) before the period of time in which the current selection of matching card 310(a-n) terminates may be indicative of the individual's impulsivity and disregard for waiting until the period of time in which the current selection of matching card 310(a-n) is displayed terminates. Such disregard may be implemented in assessing the individual's cognitive function and may be weighted accordingly by cognitive function multi-touch device 110.

In an embodiment, the individual may be requested to complete the matching game cognitive exercise in different periods of time. In such an embodiment, the individual may be required to complete the matching game cognitive exercise in a low-stress period of time as well as in a high-stress period of time. The low-stress period of time may include a period of time that is sufficient for the individual to complete the matching game cognitive exercise so that the individual may not have to move at a faster pace than what the individual is comfortable with to successfully complete the matching game cognitive exercise. The high-stress period of time may include a period of time that is significantly shorter than the low-stress period of time and is insufficient for the individual to complete the matching game cognitive exercise.

The individual may easily complete the matching game cognitive exercise in the low-stress period of time. However, the individual may have a significant decline in cognitive function when engaging the matching game cognitive exercise in the high-stress period of time. Thus, cognitive function multi-touch device 110 may analyze the cognitive data generated from the cognitive responses in engaging the matching game cognitive exercise in both the low-stress period of time as well as the high-stress period of time. In analyzing the cognitive data obtained from the low-stress period of time as well as the high-stress period of time, cognitive function multi-touch device 110 may provide an accurate assessment of the individual's cognitive function. The setting of the low-stress period of time as well as the high-stress period of time may be determined by setting module 550 as shown in FIG. 5 and to be discussed in further detail below.

For example, the individual first engages the matching game cognitive exercise in the high-stress period of time. The individual has 20 seconds to complete the matching game cognitive exercise with each selected matching card 310(a-n) displayed by user interface 140 for 1 second. The individual under the high stress, randomly selects matching cards 310(a-n), does so impulsively in that the individual makes multiple selections before the 1 second in which the current selection of matching card 310(a-n) is displayed, as well as selects each matching card 310(a-n) at varying locations relative to each matching card 310(a-n).

In such an example, the individual initially selects matching card 310c that includes the figure of the banana but selects matching card 310c at position 320a which is in the top-corner of matching card 310c. Position 320a is a significant distance from position 320c which is in the center of matching card 310c. Under stress due to the shortened period of time associated with the high-stress period of time for the individual to complete the matching game cognitive exercise, the individual then randomly selects matching card 310a with complete disregard as to the fact that matching card 310a includes the figure of the apple and does so before the 1 second in which matching card 310c is displayed has terminated. The individual also selects matching card 310a at position 320c which is outside of matching card 310c and a significant distance from position 320d which is in the center of matching card 310a.

The individual cannot simply emphasize on accuracy when engaging the matching game cognitive exercise during the high stress period of time. Rather the individual's fine motor skills are also exploited due to the positions 320a and 320d in which the individual selected matching card 310c and 310a being significant distances from positions 320c and 320d which are in the centers of each selected matching card 310c and 310a. Further, the randomness in the individual's selections as well as the individual's impulsiveness in selecting matching card 310a before the 1 second in which matching card 310c is displayed has terminated are also exploited. Such cognitive data may be analyzed by cognitive function multi-touch device 110 to provide an accurate assessment of the individual's cognitive function.

### Cognitive Exercise—Sequence Tracing Example

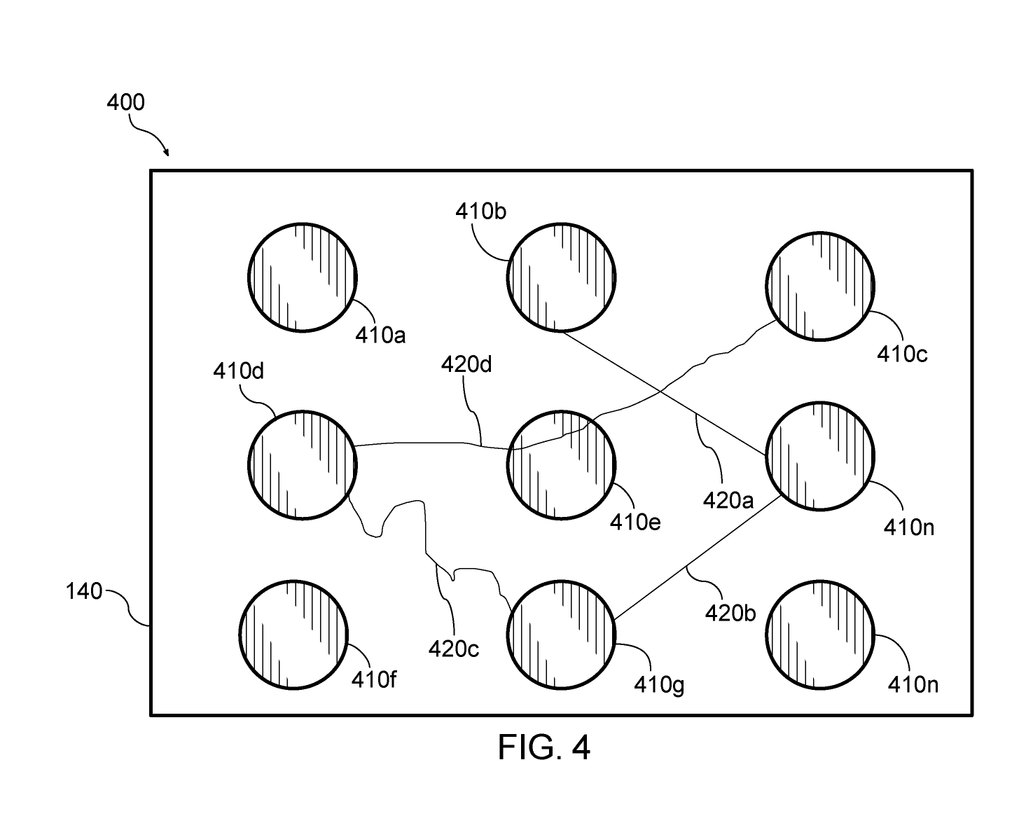

As noted above, cognitive function multi-touch device 110 may engage the individual with a cognitive exercise that includes a sequence tracing game in order to assess the cognitive function of the individual. As shown in FIG. 4, an example of a sequence tracing game displayed by user interface 140 to the individual can be seen with sequence tracing game configuration 400 that includes user interface 140 that displays a plurality of dots 410(a-n) to the individual where n is an integer greater than or equal to two.

User interface 140 may highlight a sequence of dots in which each dot 410(a-n) included in the sequence of dots is highlighted signifying the location in the sequence that each highlighted dot 410(a-n) is positioned. For example, user interface 140 may first highlight dot 410b signifying that dot 410b is the first dot in the sequence. User interface 140 may then terminate the highlighting of dot 410b and then highlight dot 410n as the second dot in the sequence following dot 410b. User interface 140 may then terminate the highlighting of dot 410n and then highlight dot 410g as the third dot in the sequence following dots 410b and 410n. User interface 140 may then terminate the highlighting of dot 410g and then highlight dot 410d as the fourth dot in the sequence following dots 410b, 410n, and 410g. User interface 140 may then terminate the highlighting of dot 410d and then highlight dot 410c as the fifth dot in the sequence following dots 410b, 410n, 410g, and 410d. Although sequence tracing game configuration 400 exhibits nine dots, any number of dots may be used that will be apparent to those skilled in the relevant art(s) without departing from the spirit and scope of the invention.

The individual may then be required to attempt to trace the sequence of dots in the order that each respective dot 410b, 410n, 410g, 410d, and 410c were highlighted by user interface 140. In order to successfully complete the trace of the sequence of dots, the individual would have to initiate the trace with dot 410b, then connect dot 410b with dot 410n, then connect dot 410n with dot 410g, then connect dot 410g with dot 410d, then connect dot 410d with dot 410c.

In an embodiment, cognitive function multi-touch device 110 may initiate the sequence tracing cognitive exercise with a first sequence by highlighting a single dot, such as dot 410b, via user interface 140. The individual may then be required to touch dot 410b. User interface 140 may then highlight a second sequence by highlighting dot 410b, terminating the highlight of dot 410b, and then highlighting dot 410n. The individual may then be required to connect dot 410b with dot 410n. After successfully completing the second sequence, user interface 140 may then highlight a third sequence by highlighting dot 410b, terminating the highlight of dot 410b, highlighting dot 410n, terminating the highlight of dot 410n, and then highlighting dot 410g. The individual may then be required to connect dot 410b with dot 410n and then connect dot 410n with dot 410g. Cognitive function multi-touch device 110 may then continue to generate a subsequent sequence after the individual successfully traces the previous sequence in which the subsequent sequence may include the sequence of dots of the previous sequence with an addition of an additional dot.

As noted above, the cognitive responses generated by the individual as the individual engages in the sequence tracing cognitive exercise may be received by user interface 140 and the cognitive data generated from the cognitive responses may be analyzed so that an assessment of the cognitive function of the individual may be determined along with a cognitive function score. For example, the sequence tracing cognitive exercise may require that the individual implement cognitive skills such as but not limited to working memory in remembering the sequence of dots, time taken to connect each dot, speed and smoothness in the trace connecting each dot, as well as avoiding dots not included in the sequence when connecting each dot in the sequence. Such an intertwining of cognitive skills may limit the emphasis that the individual can give any single cognitive skill without having a detriment to other cognitive skills so that an accurate assessment of the individual's cognitive function may be determined. For example, the individual cannot emphasize remembering each dot in the sequence but also is required to intertwine fine motor skills with memory in the speed and smoothness in completing the trace while avoiding any dot not included in the sequence.

As noted in detail above, cognitive function multi-touch device 110 may weight the cognitive data of where in the sequence that the individual incorrectly selected a dot. Cognitive function multi-touch device 110 may assign greater weight when the individual incorrectly selects a dot early in the sequence as opposed to later in the sequence because the individual could no longer remember the dots early in the sequence despite successfully completing such a sequence previously. Thus, cognitive function multi-touch device 110 may weight such incorrect selections as being indicative of a decline in cognitive function.

Cognitive function multi-touch device 110 may also weight cognitive data of the amount of time that the individual takes in connecting each dot. The greater amount of time the individual takes in connecting each dot may be indicative that the individual is uncertain as to the sequence of dots and may be assigned a greater weight as being indicative of a decline in cognitive function.

Cognitive function multi-touch device 110 may also weight cognitive data associated with the fine motor skills of the individual. Cognitive function multi-touch device 110 may receive cognitive data such as speed and smoothness generated from the cognitive responses of tracing the sequence of dots by the individual. The greater the velocity in which the individual completes the trace of the sequence of dots coupled with smooth gestures may be indicative of strong fine motor skills despite the individual having to intertwine the fine motor skills with memory skills in completing the trace of the sequence of dots. For example, paths 420a, 420b, and 420d represent smooth gestures completed by the individual in connecting each of the respective dots connected by paths 420a and 420b. Such smooth gestures may be indicative of strong cognitive function and may be weighted accordingly by cognitive function multi-touch device 110.

Conversely, the slower the velocity in which the individual completes the trace of the sequence of dots coupled with shaky and/or choppy gestures may be indicative of weak fine motor skills. For example, paths 420c and 420d represent shaky and/or choppy gestures completed by the individual in connecting each of the respective dots connected by paths 420c and 420d. Such a shaky and/or choppy gesture may be indicative of a decline in cognitive function and may be weighted accordingly by cognitive function multi-touch device 110.

Cognitive function multi-touch device 110 may also receive cognitive data associated with whether the individual bypassed each dot not included in the sequence of dots when completing the trace of the sequence of dots. For example, paths 420a, 420b, and 420c properly bypassed all dots not included in the sequence of dots. Such cognitive data may be indicative of strong fine motor skills despite having to simultaneously implement memory skills in attempting to properly connect each dot included in the sequence of dots and may be weighted accordingly by cognitive function multi-touch device 110. However, path 420d failed to bypass dot 410e when connecting dot 410d with dot 410c in which path 420d intersects dot 410e. Such a failure to bypass dot 410e which is not included in the sequence of dots when completing the trace of the sequence of dots may be indicative of weak fine motor skills and may be weighted accordingly by cognitive function multi-touch device 110.

### Example Cognitive Function System

As shown in FIG. 5, cognitive function system 500 includes cognitive data sensor server 150, network 120, cognitive data sensor system 130, cognitive function multi-touch device 110, user interface 140, and cognitive data database 190. Cognitive function multi-touch device 110 includes an analysis module 520, termination module 530, an award module 540, a setting module 550, and a determination module 560.

Modules as described above may be used by cognitive function multi-touch device 110. Examples of functionality performed by each module are referenced in the above discussion. However, the above references are examples and are not limiting. The functionality of each module may be performed individually by each module and/or be shared among any combination of modules. As referred to herein, a module may be any type of processing (or computing) device having one or more processors. For example, a module can be an individual processor, workstation, mobile device, computer, cluster of computers, set-top box, game console or other device having at least one processor. In an embodiment, multiple modules may be implemented on the same processing device. Such a processing device may include software, firmware, hardware, or a combination thereof. Software may include one or more applications and an operating system. Hardware can include, but may not be limited to, a processor, memory, and/or graphical user display.

Embodiments can work with software, hardware, and/or operating system implementations other than those described herein. Any software, hardware, and operating system implementations suitable for performing the functions described herein can be used. Embodiments are applicable to both a client and to a server or a combination of both.

The breadth and scope of the present disclosure should not be limited by any of the above-described example embodiments, but should be defined only in accordance with the following claims and their equivalents.

What is claimed is:

1. A multi-touch device for detecting a deficit in cognitive function associated with an individual based on cognitive data generated from the individual engaging in a cognitive exercise using a multi-touch device, comprising:
a user interface configured to:
engage the individual with the cognitive exercise, wherein the individual implements a plurality of cognitive skills when engaging the cognitive exercise, and
receive a plurality of cognitive responses from the individual as the individual engages the cognitive exercise;
an analysis module configured to analyze the cognitive data generated from the plurality of cognitive responses to determine an assessment of the cognitive function associated with the individual; and
a determination module configured to determine a cognitive function score from the assessment of the cognitive function associated with the individual, wherein the cognitive function score is representative of the cognitive function of the individual.

2. The multi-touch device of claim 1, wherein the user interface is further configured to:
display to the individual a plurality of cards with each card initially displayed so that each figure associated with each card is hidden from display to the individual, wherein the plurality of cards includes a plurality of matching pairs with each respective pair depicting a substantially similar figure;
receive a selection from the individual, wherein the selection is a selected card from the plurality of cards that the individual requests to examine the figure associated with the selected card; and
display to the individual the figure associated with the selected card for a time interval.

3. The multi-touch device of claim 2, further comprising:
an award module configured to award a match when the individual selects a first card with a first selection and a second card with a second selection that are a matching pair, wherein the first selection and the second selection are contiguous.

4. The multi-touch device of claim 3, wherein the analysis module is further configured to analyze the cognitive data generated from the plurality of cognitive responses generated by the individual when selecting each card to determine the assessment of the cognitive function associated with the individual.

5. The multi-touch device of claim 4, wherein the determination module is further configured to determine the cognitive function score from the assessment of the cognitive function associated with the individual based on the cognitive data generated from the plurality of cognitive responses executed by the individual when selecting each card.

6. The multi-touch device of claim 5, further comprising:
a termination module configured to terminate the display of the selected card to the individual via the user interface when the time interval has lapsed and/or the individual selects the second card so that a single card is displayed to the individual.

7. The multi-touch device of claim 6, further comprising:
a setting module configured to set a period of time for the individual to attempt to identify each match included in the plurality of cards.

8. The multi-touch device of claim 7, wherein the analysis module is further configured to analyze the cognitive data generated from the plurality of cognitive responses generated by the individual when selecting each card generated during the period of time to determine the assessment of the cognitive function associated with the individual.

9. The multi-touch device of claim 8, wherein the determination module is further configured to determine the cognitive function score from the assessment of the cognitive function associated with the individual based on the plurality of cognitive responses generated during the period of time.

10. The multi-touch device of claim 9, further comprising a setting module configured to:
set a low-stress period of time for the individual to attempt to identify each match included in the plurality of cards, wherein the low-stress period of time is of sufficient length for the individual to attempt to identify each match included in the plurality of cards; and
set a high-stress period of time for the individual to attempt to identify each match included in the plurality of cards, wherein the high-stress period of time is less than the low-stress period of time resulting in the individual having to operate at a faster pace to attempt to identify each match included in the plurality of cards as compared to the low-stress period of time.

11. The multi-touch device of claim 10, wherein the analysis module is further configured to:
analyze the cognitive data generated from the plurality of cognitive responses generated by the individual when selecting each card generated during the low-stress period of time; and
analyze the cognitive data generated from the plurality of cognitive responses generated by the individual when selecting each card generated during the high-stress period of time.

12. The multi-touch device of claim 11, wherein the determination module is further configured to determine the cognitive function score from the assessment of the cognitive function associated with the individual based on the plurality of cognitive responses generated during the low-stress period of time and the high-stress period of time.

13. The multi-touch device of claim 12, wherein the determination module is further configured to:
compare the cognitive data generated by the individual to average cognitive data to determine the cognitive function score, wherein the average cognitive data is the cognitive data generated by an average individual with a substantially similar age as the individual.

14. The multi-touch device of claim 13, wherein the user interface is further configured to:
display a plurality of dots to the individual;
highlight a sequence of dots from the plurality of dots to the individual; and
receive a trace of the sequence of dots from the individual.

15. The multi-touch device of claim 14, wherein the analysis module is further configured to analyze the cognitive data generated from the plurality of cognitive responses generated by the individual when completing the trace of the sequence of dots to determine the assessment of the cognitive function associated with the individual.

16. The multi-touch device of claim 15, wherein the determination module is further configured to determine the cognitive function score from the assessment of the cognitive function associated with the individual based on the plurality of cognitive responses generated by the individual when completing the trace of the sequence of dots.

17. The multi-touch device of claim 16, wherein the user interface is further configured to:
highlight an initial sequence of dots from the plurality of dots to the individual;
receive a trace of the initial sequence of dots from the individual;
add an additional dot to the initial sequence of dots after the individual successfully completes the trace of the initial sequence of dots to generate a subsequent sequence of dots; and
continue to add an additional dot to each preceding sequence of dots after the individual successfully completes the trace of each preceding sequence of dots to generate the subsequent sequence of dots until the individual fails to correctly trace the subsequent sequence of dots, wherein each subsequent sequence of dots includes the preceding sequences of dots with each additional dot added to the subsequent sequence of dots.

18. The multi-touch device of claim 17, wherein the analysis module is further configured to analyze the cognitive data generated from the plurality of cognitive responses generated by the individual when completing each trace of each sequence of dots to determine the assessment of the cognitive function associated with the individual.

19. The multi-touch device of claim 18, wherein the determination module is further configured to determine the cognitive function score from the assessment of the cognitive function associated with the individual based on the plurality of cognitive responses generated by the individual when completing each trace of each sequence of dots.

20. The multi-touch device of claim 19, wherein the determination module is further configured to:
determine which dot in the sequence of dots that the individual incorrectly incorporated into the trace of the sequence of dots;
allocating a greater weight when the dot in the sequence of dots that the individual incorrectly incorporated into the trace of the sequence of dots is earlier in the sequence of dots as compared to when the dot in the sequence of dots that the individual incorrectly incorporated into the trace of the sequence of dots is later in the sequence of dots; and
determine the cognitive function score incorporating the allocated weight indicating an increased deficit in the cognitive function of the individual.

21. The multi-touch device of claim 20, wherein the determination module is further configured to:
measure an amount of time taken before the individual selects each dot when completing the trace of the sequence of dots;
allocate a greater weight as the amount of time taken before the individual selects each dot increases; and
determine the cognitive function score incorporating the allocated weight indicating an increased deficit in the cognitive function of the individual.

22. The multi-touch device of claim 21, wherein the determination module is further configured to:
determine whether the individual bypassed each dot not included in the sequence of dots when the individual completed the trace of the sequence of dots;
allocate a greater weight when the individual fails to bypass each dot not included in the sequence of dots when the individual completed the trace of the sequence of dots; and
determine the cognitive function score incorporating the allocated weight indicating an increased deficit in the cognitive function of the individual.

23. A method for detecting a deficit in cognitive function associated with an individual based on cognitive data generated from the individual engaging in a cognitive exercise using a multi-touch device, comprising:
engaging the individual with the cognitive exercise via a user interface of the multi-touch device, wherein the individual implements a plurality of cognitive skills when engaging the cognitive exercise;
receiving via the user interface a plurality of cognitive responses from the individual as the individual engages the cognitive exercise;
analyzing the cognitive data generated from the plurality of cognitive responses to determine an assessment of the cognitive function associated with the individual; and
determining a cognitive function score from the assessment of the cognitive function associated with the individual, wherein the cognitive function score is representative of the cognitive function of the individual.

24. The method of claim 23, further comprising:
displaying to the individual via the user interface a plurality of cards with each card initially displayed so that each figure associated with each card is hidden from display to the individual, wherein the plurality of cards includes a plurality of matching pairs with each respective pair depicting a substantially similar figure;
receiving a selection from the individual via the user interface, wherein the selection is a selected card from the plurality of cards that the individual requests to examine the figure associated with the selected card;
displaying to the individual via the user interface the figure associated with the selected card for a time interval;
awarding a match when the individual selects a first card with a first selection and a second card with a second selection that are a matching pair, wherein the first selection and the second selection are contiguous;
analyzing the cognitive data generated from the plurality of cognitive responses generated by the individual when selecting each card to determine the assessment of the cognitive function associated with the individual; and
determining the cognitive function score from the assessment of the cognitive function associated with the individual based on the cognitive data generated from the plurality of cognitive responses executed by the individual when selecting each card.

25. The method of claim 24, further comprising:
terminating the display of the selected card to the individual via the user interface when the time interval has lapsed and/or the individual selects the second card so that a single card is displayed to the individual.

26. The method of claim 25, further comprising:
setting a period of time for the individual to attempt to identify each match included in the plurality of cards;
analyzing the cognitive data generated from the plurality of cognitive responses generated by the individual when selecting each card generated during the period of time to determine the assessment of the cognitive function associated with the individual; and
determining the cognitive function score from the assessment of the cognitive function associated with the individual based on the plurality of cognitive responses generated during the period of time.

27. The method of claim 26, further comprising:
setting a low-stress period of time for the individual to attempt to identify each match included in the plurality of cards, wherein the low-stress period of time is of sufficient length for the individual to attempt to identify each match included in the plurality of cards; and
setting a high-stress period of time for the individual to attempt to identity each match included in the plurality of cards, wherein the high-stress period of time is less than the low-stress period of time resulting in the individual to operate at a faster pace to attempt to identify each match included in the plurality of cards as compared to the low-stress period of time.

28. The method of claim 27, further comprising:
analyzing the cognitive data generated from the plurality of cognitive responses generated by the individual when selecting each card generated during the low-stress period of time;
analyzing the cognitive data generated from the plurality of cognitive responses generated by the individual when selecting each card generated during the high-stress period of time; and
determining the cognitive function score from the assessment of the cognitive function associated with the individual based on the plurality of cognitive responses generated during the low-stress period of time and the high-stress period of time.

29. The method of claim 28, further comprising:
comparing the cognitive data generated by the individual to average cognitive data to determine the cognitive function score, wherein the average cognitive data is the cognitive data generated by an average individual with a substantially similar age as the individual.

30. The method of claim 23, further comprising:
displaying a plurality of dots via the user interface to the individual;
highlighting a sequence of dots from the plurality of dots via the user interface to the individual;
receiving a trace of the sequence of dots from the individual via the user interface;
analyzing the cognitive data generated from the plurality of cognitive responses generated by the individual when completing the trace of the sequence of dots to determine the assessment of the cognitive function associated with the individual; and
determining the cognitive function score from the assessment of the cognitive function associated with the individual based on the plurality of cognitive responses generated by the individual when completing the trace of the sequence of dots.

31. The method of claim 30, further comprising:
highlighting an initial sequence of dots from the plurality of dots via the user interface to the individual;
receiving a trace of the initial sequence of dots from the individual via the user interface;
adding an additional dot to the initial sequence of dots after the individual successfully completes the trace of the initial sequence of dots to generate a subsequent sequence of dots;
continuing to add an additional dot to each preceding sequence of dots after the individual successfully completes the trace of each preceding sequence of dots to generate the subsequent sequence of dots until the individual fails to correctly trace the subsequent sequence of dots, wherein each subsequent sequence of dots includes the preceding sequences of dots with each additional dot added to the subsequent sequence of dots;
analyzing the cognitive data generated from the plurality of cognitive responses generated by the individual when completing each trace of each sequence of dots to determine the assessment of the cognitive function associated with the individual; and
determining the cognitive function score from the assessment of the cognitive function associated with the individual based on the plurality of cognitive responses generated by the individual when completing each trace of each sequence of dots.

32. The method of claim 31, further comprising:
determining which dot in the sequence of dots that the individual incorrectly incorporated into the trace of the sequence of dots;
allocating a greater weight when the dot in the sequence of dots that the individual incorrectly incorporated into the trace of the sequence of dots is earlier in the sequence of dots as compared to when the dot in the sequence of dots that the individual incorrectly incorporated into the trace of the sequence of dots is later in the sequence of dots; and
determining the cognitive function score incorporating the allocated weight indicating an increased deficit in the cognitive function of the individual.

33. The method of claim 32, further comprising:
measuring an amount of time taken before the individual selects each dot when completing the trace of the sequence of dots;
allocating a greater weight as the amount of time taken before the individual selects each increases; and
determining the cognitive function score incorporating the allocated weight indicating an increased deficit in the cognitive function of the individual.

34. The method of claim 33, further comprising:
determining whether the individual bypassed each dot not included in the sequence of dots when the individual completed the trace of the sequence of dots;
allocating a greater weight when the individual fails to bypass each dot not included in the sequence of dots when the individual completed the trace of the sequence of dots; and
determining the cognitive function score incorporating the allocated weight indicating an increased deficit in the cognitive function of the individual.
